(19) United States
(12) Patent Application Publication
(10) Pub. No.: US 2021/0342776 A1
(43) Pub. Date: Nov. 4, 2021

(54) SYSTEM AND METHOD FOR PROVIDING WORKER POSITION

(71) Applicant: Nippon Gas Co., LTD., Tokyo (JP)

(72) Inventor: Shinji Wada, Tokyo (JP)

(21) Appl. No.: 17/271,329

(22) PCT Filed: Aug. 22, 2019
(86) PCT No.: PCT/JP2019/032836

§ 371 Date: Feb. 25, 2021

(30) Foreign Application Priority Data
Aug. 29, 2018 (JP) 2018-160447
Jun. 12, 2019 (JP) 2019-109430

(51) Int. Cl. G06Q 10/08; G06Q 10/06; H04L 29/08

(52) U.S. Cl. CPC G06Q 10/0833; H04L 67/18; G06Q 10/063114

(57) ABSTRACT

A location providing system is provided. The system transmits, via a communication device to a first computer device used by a consumer, notification of the work from the operator to the consumer, receives, from the first computer device, a request for receiving current location for the operator who performs the work associated with the notification, in response to the request, obtains from the storage device, the operator information associated with the work, and transmits, to the first computer device, the obtained current location.

### TECHNICAL FIELD

The disclosure relates to a system for providing location where an operator is currently located, and more specifically, to a system for providing location where an operator who performs a work related to a gas service is currently located.

### BACKGROUND ART

Normally, gas used in a standard home is supplied to a consumer by a gas supply company providing a gas service. For example, the gas supply company supplies gas to the consumer in a manner such that a gas cylinder filled with LP (Liquid Petroleum) gas is placed in the consumer's home, and gas is supplied from the gas cylinder.

In the above manner for supplying gas, it is necessary for the gas supply company to replace the gas cylinder to avoid the shortage of gas, and to open a gas cock when the consumer moves for example. In such case, the operator performs the works such as replacing the gas cylinder, placing a gas meter, and opening the gas cock. In order to perform the above works, the operator needs to visit the consumer's home, and the consumer needs to stay in the home to accept the operator.

For the above works, the consumer may wish to know when the operator visits (arrives at) the consumer's home.

PTL 1 discloses the system for predicting the time to deliver the gas cylinder filled with LP gas. The system disclosed in PTL 1 predicts the time when it is necessary to replace the gas cylinder based on the historical usage of gas consumed by the consumer. The deliverer delivers the gas cylinder according to the predicted time, which can avoid the shortage of gas in the gas cylinder.

### CITATION LIST

### Patent Literature

PTL 1: Japanese Patent Laid-Open No. 2017-162278

### SUMMARY OF INVENTION

### Technical Problem

In the system disclosed in PTL 1, the deliverer visits the consumer's home according to the predicted time to replace the gas cylinder. This system notifies the consumer with the predicted time, but does not allow the consumer to predict when the deliverer visits (arrives at) the consumer's home.

In light of the above, the embodiment provides the system for allowing the consumer to predict when the operator arrives at e consumer's home.

### Solution to Problem

According to an embodiment, a system for providing location where an operator who performs a work related to a gas service is provided. The system includes a controller, a communication device, and a storage device. The storage device stores operator information associated with the work. The controller configured to transmit, via the communication device to a first computer device used by a consumer, notification of the work from the operator to the consumer, receive, via the communication device from the first computer device, a request for receiving current location for the operator who performs the work for the notification, in response to the request, obtain from the storage device, the operator information associated with the work, and transmit, via the communication device to the first computer device, the obtained current location.

According to another embodiment, a computer-implemented method for providing location where an operator who performs a work related to a gas service is provided. The computer stores operator information associated with the work in a storage device. The method includes transmitting, to a first computer device, notification of the work from the operator to the consumer, receiving, from the first computer device, a request for receiving current location for the operator who performs the work for the notification, in response to the request, obtaining from the storage device, the operator information associated with the work, and transmitting, to the first computer device, the obtained current location.

According to the embodiment, the consumer can be provided with the current location for the operator who performs the work related to the gas service in real time, and can predict when arrives at the consumer's home.

### BRIEF DESCRIPTION OF DRAWINGS

FIG. 1 shows a block diagram illustrating a configuration of a system for providing location where an operator is currently located according to a first embodiment.

FIG. 2 shows a block diagram illustrating a detailed configuration of a server computer and computer devices shown in FIG. 1.

FIG. 3 shows a flow diagram illustrating operations performed by a location providing system according to a first embodiment.

FIG. 4 shows a diagram illustrating a work data table.

FIG. 5 shows a diagram illustrating a consumer data table.

FIG. 6 shows a diagram illustrating an operator data table.

FIG. 7 shows a flow diagram illustrating operations performed by a location providing system according to a second embodiment.

FIG. 8 shows a flow diagram illustrating operations performed by a location providing system according to a third embodiment.

### DESCRIPTION OF EMBODIMENTS

### First Embodiment

A location providing system 100 is described in detail according to a first embodiment. The location providing system 100 allows a consumer provided with a gas service supplied by a gas supply company to know location where an operator using a computer device is currently located. Hereinafter, the gas service supplier is referred to as a “gas supply company.” The “operator” encompasses a deliverer who delivers a gas cylinder, an operator who opens and closes a gas cock, and a personnel who visits the consumer's home for other gas service (e.g. security guard, inspector, meter reader).

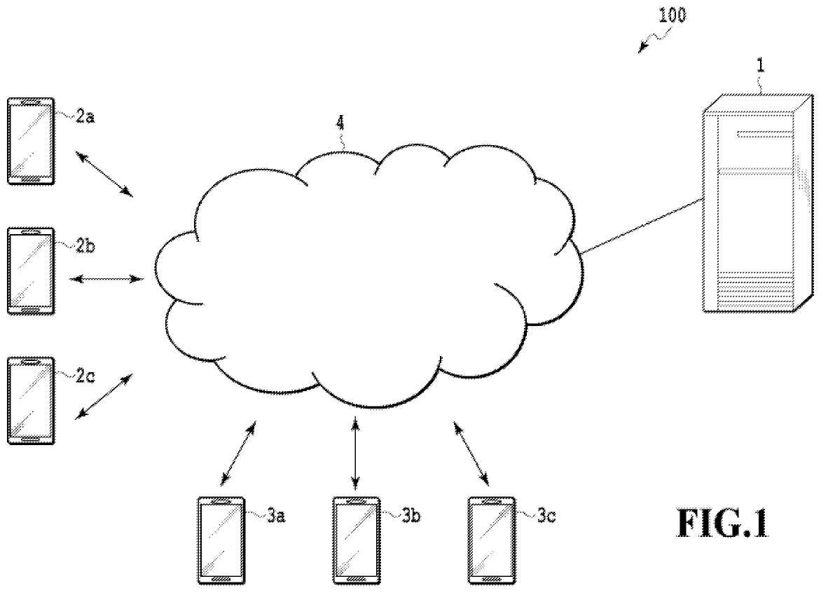

FIG. 1 shows a configuration of the location providing system 100. The location providing system 100 includes a server computer 1, a plurality of computer devices 2a, 2b and 2c (collectively referred to as “computer device 2”), and a plurality of computer devices 3a, 3b and 3c (collectively referred to as “computer device 3”). The server computer 1, the computer device 2, and the computer device 3 are inter-connected via a network 4.

The server computer 1 provides the consumer with location (current location) where the operator to visit the consumer's home is currently located. The server computer 1 may be a computer device such as a host computer for executing processes according to a request from a client, and may be implemented in single computer device or a plurality of computer devices. The server computer 1 may implement a Web server, and may transmit, to the computer device 2 and the computer device 3, information for a HTML document according to HTTP (HyperText Transfer Protocol).

Each of the plurality of computer devices 2 is used by the consumer. The computer device 2 may include but not limited to a mobile phone such as smartphone, a personal digital assistant (PDA) such as tablet computer, a desktop type personal computer, notebook computer, and a computer installed in a data center. The computer device 2 may implement a Web browser and may display a HTTP document transmitted from the server computer 1.

Each of the plurality of computer devices 3 is used by the operator. The computer device 3 may be configured to obtain, using a Global Positioning System (GPS), the current information (current location) where the operator using the computer device 3 is currently located according to the location where the computer device 3 is located. The computer device 3 may include any computer device such as smartphone that is capable of obtaining the location information. The scheme of obtaining the location information is not limited. For example, the computer device 3 may calculate the current location, or the server computer 1 may calculate the current location based on the GPS signal from the computer device 3. The computer device 3 may implement a Web browser and may display a HTTP document transmitted from the server computer 1.

The network 4 may include a public network such as internet and/or a private network such as dedicated line.

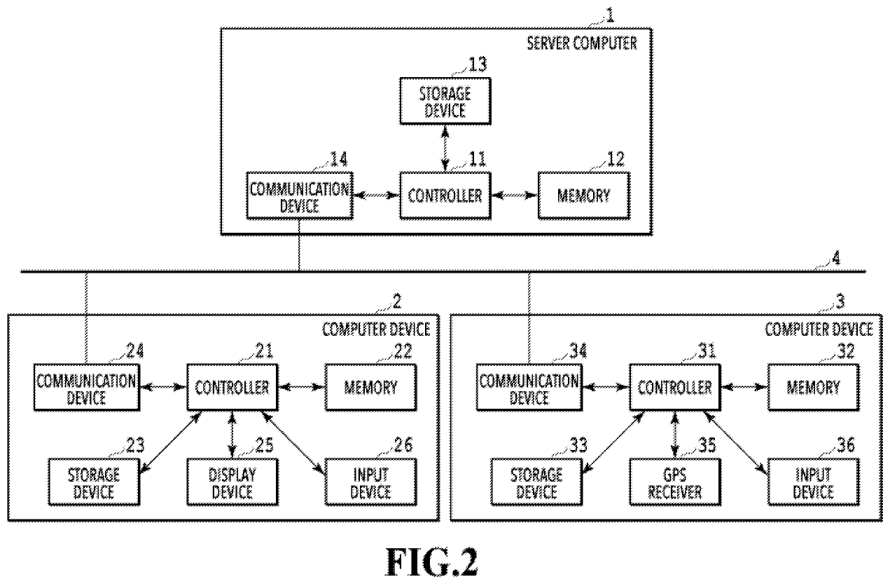

Next, referring to FIG. 2, a detailed configuration for the server computer 1, the computer device 2, and the computer device 3 are described. The server computer 1, the computer device 2, and the computer device 3 include similar components each other, and thus the description for such components will be omitted.

<Configuration for Server Computer 1>

The server computer 1 includes a controller 11, a memory 12, a storage device 13, and a communication device 14. The controller 11 may be referred to as processor, and may control the components of the server computer 1 and perform data operation. Also, the controller 11 may read and execute the program from the storage device 13 for performing the processes.

The memory 12 may include a volatile data storage device for storing data transmitted from the computer device 2 and the computer device 3, a computer executable instruction, and data operated with the instruction. The memory 12 may include a RAM (random access memory) such as SRAM (static RAM) and DRAM (dynamic RAM) for example.

The storage device 13 may include a non-volatile data storage device for storing the program, map data related to the location information, and a data table (database management system (DBMS) table). The storage device 13 may include a non-volatile semiconductor memory such as ROM (read only memory), magnetic storage device (hard disk drive), and optical storage device (optical disk drive).

The communication device 14 may include a network interface for transmitting and receiving data and control information to/from the computer device 2 and computer device 3 via the network 4. More specifically, the communication device 14 may establish a TCP/IP socket according to HTTP and may transmit and receive HTML document and data embedded in HTML. The communication device 14 may include a network card according to TCP/IP protocol (e.g. LAN card) for example.

<Configuration for Computer Device 2>

The computer device 2 may include a controller 21, a memory 22, a storage device 23, a communication device 24, a display device 25, and input device 26. The controller 21, the memory 22, the storage device 23, and the communication device 24 include similar functions to the controller 11, the memory 12, the storage device 13, and the communication device 14 in the server computer 1. The storage device 23 may store the program for allowing the consumer to display a screen interface in which the current location for operator is displayed.

The display device 25 may display the screen interface for displaying the current location for the operator by the controller 21 executing the program stored in the storage device 23. More specifically, the display device 25 may display the HTML document transmitted from the server computer 1 by the controller 21 executing the Web browser. The display device 25 may be implemented as a display device integrated with the computer device 2 (e.g. touch panel display device) or as a display device connected to the computer device 2 (e.g. display board).

The input device 26 may include any input device for allowing the consumer to input information such as touch panel, mouse, and keyboard for example.

<Configuration for Computer Device 3>

The computer device 3 may include a controller 31, a memory 32, a storage device 33, a communication device 34, a GPS receiver 35, and an input device 36. The controller 31, the memory 32, the storage device 33, and the communication device 34 include similar functions to the controller 11, the memory 12, the storage device 13, and the communication device 14 in the server computer 1. The input device 36 includes similar functions to the input device 26 in the computer device 2.

The GPS receiver 35 may include an antenna for receiving periodically GPS signal from a GPS satellite. The controller 31 may include a processor or ASIC, and may calculate, based on the GPS signal received by the GPS receiver 35, the location where the operator using the computer device 3 is currently located.

<Operations Performed by Location Providing System 100>

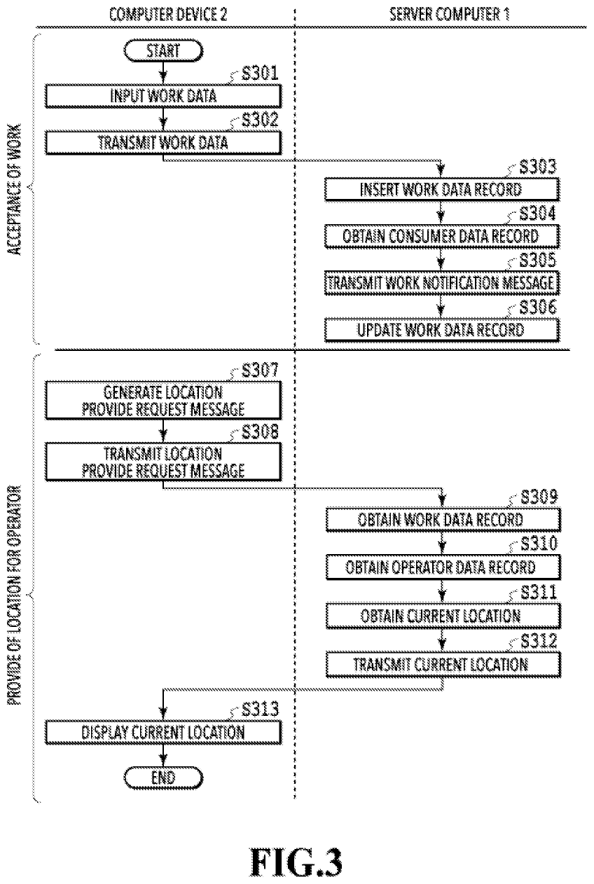

Next, referring to the flow diagram of FIG. 3, operations performed by the location providing system 100 are described. The embodiment in FIG. 3 provides the example in which a work related to the gas service performed by the operator corresponds to the work for delivering a gas cylinder performed by a deliverer, and the server computer 1 provides the consumer with the current location for the operator via the computer device 2. The above-mentioned work may include a work for checking and placing the gas apparatus and metering the gas meter for example.

In the operations in FIG. 3, the server computer 1 and the computer device 2 or the server computer 3 exchange the data inputted into the Web document according to HTTP. The Web document is transmitted from the server computer 1 to the computer device 2 or the server computer 3.

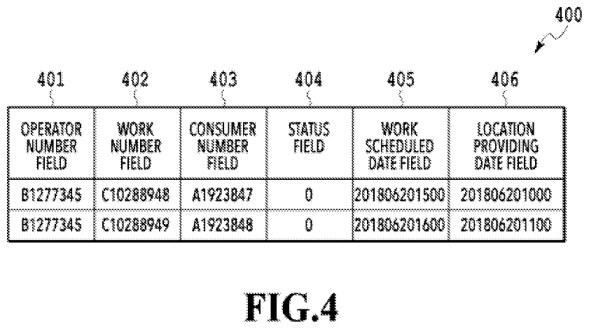

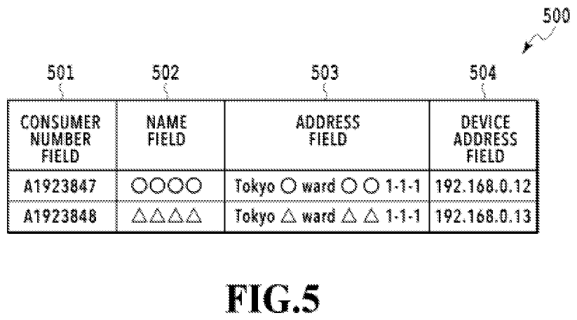

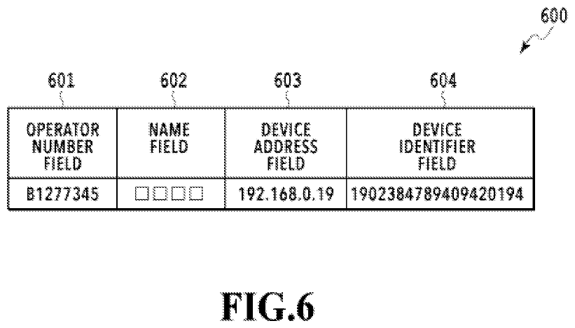

In order to implement the operations for providing the current location, data stored in the storage device 13 of the server computer 1 is described with reference to FIGS. 4 to 6. FIG. 4 shows a work data table 400. FIG. 5 shows a consumer data table 500. FIG. 6 shows an operator data table 600. The work data table 400, the consumer data table 500, and the operator data table 600 respectively are embodied as a data table implemented in the database management system (DBMS).

<Structure for Work Data Table 400>

The work data table 400 may be used for managing the works performed by the operator. As shown in FIG. 4, the work data table 400 may include an operator number (operator information) field 401, a work number field 402, a consumer number field 403, a status field 404, a work scheduled date field 405, and a location providing date field 406. The work data table 400 may optionally include a work type field (not shown). The work data table 400 may store a unique data record for each work.

When accepting new work, new data record is inserted in the work data table 400, and new work number is assigned and set in the work number field 402. Also, when accepting new work, new operator is assigned to the work, the operator number corresponding to the operator is set in the operator number field 401, and the consumer number corresponding to the consumer for which the work is performed is set in the consumer number field 403. When assigning new operator, the controller 11 of the server computer 1 may search, based on the operator's information, a predetermined condition such as an area (address) where the consumer lives, a work description, and work date, and assign the operator for which the condition is matched. The operator's information may be associated with the value set in the operator number field 401, and may include an area where the operator can cover, a work description, and work date.

In the status field 404, a value is set indicating the progress for the work, for example, “0: uncompleted” as an initial value, “1: notified” when the work notification message is transmitted, and “2: completed” when the work is completed. In the work scheduled date field 405, a value is set indicating the date scheduled for the work (e.g. date scheduled for delivering the gas cylinder in the embodiment). In the location providing date field 406, a value is set indicating the date by certain period of time earlier than the work scheduled date set in the work scheduled date field 405. When the date set in the location providing date field 406 is reached, the location where the operator is currently located and approaching the consumer's home is determined and provided to the consumer. In the work type field (optional), a value is set indicating the type for the work, for example, “1: delivery of gas cylinder” and “2: inspection of gas meter”.

The certain period of time may be preset. For example, the certain period of time may include the time (offset time) such as 30 minutes, one hour, and two hours. The offset time may be set for each operator, each work, and/or each work type, or set in common for all work types. In this case, the location providing date may be calculated based on the work scheduled date and offset time, that is, the location providing date is set to the date by the offset time earlier than the work scheduled date (i.e. location providing date=work scheduled date−offset time).

<Structure for Consumer Data Table 500>

As shown in FIG. 5, the consumer data table 500 may include a consumer number field 501, a name field 502, an address field 503, and a device address field 504. The consumer data table 500 may store a unique data record for each consumer. When assigning new consumer number to the consumer, new data record is inserted in the data table 500, and the assigned consumer number is set in the consumer number field 501. Corresponding consumer's name, consumer's address (consumer's home address), and device address (e.g. IP address) for the computer device 2 used by the consumer are set in the name field 502, the address field 503, and the device address field 504 respectively.

<Structure for Operator Data Table 600>

As shown in FIG. 6, the operator data table 600 may include an operator number field 601, a name field 602, a device address field 603, and a device identifier field 604. The operator data table 600 may store a unique data record for each operator. When assigning new operator number to the operator, new data record is inserted in the operator data table 600, and the assigned operator number is set in the operator number field 601. Corresponding device address (e.g. IP address) and identifier (e.g. serial number and/or MAC address) for the computer device 3 used by the operator are set in the device address field 603 and the device identifier field 604 respectively.

<Acceptance of Work>

Operations in steps S301 to S306 in FIG. 3 correspond to operations in which the gas supply company (server computer 1) accepts the work related to the gas service, and notifies the work scheduled date to the consumer (computer device 2). These operations are usually performed before the work scheduled date (e.g. earlier by two months, one month, three weeks).

In step S301, the consumer inputs, in the screen interface displayed in the display device 25 of the computer device 2, work data for requesting delivery of the gas cylinder. The screen interface may include the Web document transmitted from the server computer 1, and the Web document accepts the work data inputted by the consumer. The screen interface sets the predetermined data format for inputting the work data. In the Web document, a program may be embedded for executing dynamic process in association with a CGI script etc. As such, when it is necessary to change the data format for inputting the work data, only updating the program stored in the server computer 1 may allow to change the data format without updating the program stored in the computer device 2.

The work data to be inputted may include at least the own consumer number and the delivery desired date (work desired date). Once the work data is inputted, the controller 21 of the computer device 2 transmits, via the communication device 24, the work data to the server computer 1 (step S302). The controller 11 of the server computer 1 receives the work data via the communication device 14, and inserts, in the work data table 400, the work data record corresponding to the work data (step S303).

For the data record shown in FIG. 4, the number “C10288948” is set in the work number field 402 as the number indicating the work for the consumer (e.g. consumer A) who inputs the work data in step S301, “201806201500” (representing Jun. 20, 2018, 15:00) is set in the work scheduled date field 405, and the date “201806201000” (representing Jun. 20, 2018, 10:00, that is, the date by five hours than the work scheduled date) is set in the location providing date field 406. Also, for the data record for the consumer A, corresponding values are set in the operator number field 401 and status field 404, respectively. Further, the value “1: delivery for gas cylinder” may set in the work type field (optional). Once the operator for delivering the gas cylinder is assigned for the consumer A according to the above-mentioned condition, the controller 11 of the server computer 1 assigns the operator number corresponding to the operator, and set the operator number in the operator number field 401.

In the example in FIG. 4, the work number “C10288949” is also set in the work number field 402 as the number indicating the work for the consumer B (e.g. delivery for gas cylinder).

For two data records shown in FIG. 4, the same operator number “B1277345” is set in the operator number field 401, and the same date is set in the work scheduled date field 405 (in the example in FIG. 4, the date “20180620” (representing Jun. 20, 2018) is set for the both data records). In this case, it means that the same operator assigned number “B1277345” visits both the consumer A's home and the consumer B's home, and performs the works for the consumer A and the consumer B.

Then, the controller 11 of the server computer 1 obtains the consumer data record from the consumer data table 500 based on the consumer number set in the consumer number field 403 of the work data record inserted into the work data table 400 in step S303 (step S304). For two data records shown in FIG. 5, the number “A1923847” (assigned for the consumer A) and the number “A1923848” (assigned for the consumer B) are set in the consumer number field 501, respectively.

Then, the controller 11 generates a work notification message based on the data in the work data table 400 (data set in the fields 401 to 406 inserted in step S303). The controller 11 transmit, via the communication device 14, the work notification message to the address of the computer device 2 which is set in the device address field 504 of the consumer data record (e.g. for the consumers A and B) obtained in step S304 (step S305). The work notification message is to notify the consumer for which the operator performs the work, and includes at least the consumer number and the work scheduled date (corresponding to the work desired date inputted in S301) set in the consumer data record obtained in step S304.

Additionally, the controller 11 transmits the message indicating that the current location can be provided. Once the computer device 2 receives this message, the consumer can recognize that the current location can be obtained for the operator who plans to visit the consumer's home from the date included in the work notification message (corresponding to the date set in the location providing date field 406). It is noted that the above message may be included in the work notification message.

Then, the controller 11 updates the value set in the status field 404 of the work data record inserted into the work data table 400 in step S303 (step S306). In the example in FIG. 3, since the work notification message is transmitted in step 305, the value is updated from “0: uncompleted” to “1: notified” in the status field 404. After the operator completes the work in the consumer's home, and inputs the information indicating that the work is completed (including at least corresponding work number), the controller 11 updates the value with “2: completed” set in the status field 404.

Although the embodiment provides the example in which the computer device 2 (consumer) transmits the work data to the server computer 1, and the server computer 1 generates the work data record to be inserted into the work data table 400, the embodiment is not limited to the example. For example, the computer device 3 (operator) may transmit the work data to the server computer 1, and the server computer 1 may generate the work data record. In this case, the work data is transmitted in the form of the Web document. Also, the server computer 1 may automatically insert the work data record into the work data table 400. For example, if the server computer 1 automatically determine when the gas cylinder is replaced in the consumer's home, the work data record is generated for the replacement work of gas cylinder according to the determination.

As described above, the operations for accepting the work in steps S301 to S306 end.

<Provide of Location for Operator>

Next, the operations in steps S307 to S313 in FIG. 3 are described. According to these operations, the consumer can know the location where the operator is currently located after the date set in the location providing date field 406 (e.g. earlier by five hours than the work scheduled date). These operations are normally performed on the work scheduled date.

After the operations in steps S301 to S306 are performed, the consumer can see, on the screen interface of the computer device 2, the work to be performed for the consumer. This work can be seen by the consumer inputting the own consumer number on the screen interface, the computer device 2 transmitting the consumer number to the server computer 1, and the server computer 1 obtaining the work data record corresponding to the consumer number from the work data table 400. The obtained work data record is embedded in the Web document, and displayed on the display device 25 of the computer device 2 for each work.

In step S307, the consumer selects, on the screen interface, the work to be performed for the consumer, and the controller 21 of the computer device 2 generates a location provide request message. The location provide request message may include at least the work number corresponding to the selected work and/or the consumer number. Then, the controller 21 transmits, via the communication device 24, the location provide request message to the server computer 1 (step S308). The location provide request message is set with the IP address and MAC address of the computer device 2 as source address. According to the operation in S308, the computer device 2 (consumer) can request the server computer 1 to provide the current location for the operator who visits the consumer's home.

Although the embodiment provides the example in which the consumer selects the work to be performed for the consumer, the consumer may input, on the screen interface, the own consumer number and the work number corresponding to the work.

Then, the controller 11 of the server computer 1 receives, via the communication device 14, the location provide request message, and obtains the work data record from the work data table 400 based on the work number and/or consumer number included in the location provide request message (step S309). Among the work data records, the work data record is obtained set, in the status field 404, the value indicating that the work is uncompleted (i.e. value other than “2: completed”) and set, in the location providing date field 406, the date earlier than the date data of performing the operation in step S309.

Then, the controller 11 obtains the operator data record from the operator data table 600 based on the operator number set in the operator number field 401 of the work data record obtained in step S309 (step S310). Then, the controller 11 obtains the location where the operator corresponding to the operator number set in the operator number field 401 is currently located (step S311).

In the computer device 3, the current location for the operator is calculated by the GPS receiver 35 periodically receiving the GPS signals from the GPS satellite, and the controller 31 calculating the location where the computer device 3 is currently located based on the GPS signals. In this case, the controller 31 transmits, via the communication device 34, the calculated current location as well as the device identifier of the computer device 3 (e.g. serial number and/or MAC address) to the server computer 1. The controller 11 of the server computer 1 receives the current location and the device identifier, compares the received device identifier with the device identifier set in the device identifier field 604 of the operator data record obtained in step S310, and determines whether the calculated current location is for the operator.

Alternatively, the server computer 1 may receive the GPS signals from the computer device 3, and may calculate the location where the computer device 3 is currently located. Also in this case, the controller 11 of the server computer 1 compares the device identifier received from the computer device 3 with the device identifier set in the device identifier field 604 of the operator data record obtained in step S310.

Although the embodiment provides the example in which the computer device 3 receives the GPS signals, and calculates the current location for the operator, the computer device 3 may periodically transmit the GPS signals received from the GPS satellite (or the calculated current location) to the server computer 1. Also, the computer device 3 may transmit the GPS signals (or the calculated current location) to the server computer 1 in response to the request from the server computer 1. In this case, the controller 11 of the server computer 1 transmits, via the communication device 14, the request message to the address set in the device address field 603 of the operator data record obtained in step S310. In the case of transmitting the GPS signals (or the calculated current location) in response to the request from the server computer 1, it can reduce the data traffic between the server computer 1 and the computer device 3.

Then, the controller 11 of the server computer 1 transmits the current location calculated in step S311 to the computer device 2 that transmitted the location provide request message (step S312). The current location is transmitted in the form of the Web document. Since the location provide request message is set with the IP address and MAC address of the computer device 2 as the source address, the current location is transmitted to this source address.

Then, the controller 21 of the computer device 2 receives, via the communication device 24, the current location for the operator, and displays the current location on the display device 25 (step S313). Also, the computer device 2 may download the map data from the server computer 1, and may display the current location on the map data (overlay the current location on the map data). Further, the computer device 2 may download the consumer's address (set in the consumer data table 500), and may display the indication of the consumer's address (e.g. sign including circle or arrow) on the map data (overlay the consumer's address on the map data). Still further, the server computer 1 may embed the indication of the consumer's address in the map data, and the computer device 2 may download the map data containing the indication. In this way, the consumer can check, on the map data, the location where the operator is currently located as well as the consumer's address. It is noted that the map data is embedded in the Web document.

Instead of the above-described example, the computer device 2 may store the map data and/or the consumer's address on the storage device 23. In this case, the computer device 2 does not need to download the map data from the server computer 1, thereby reducing the data traffic between the server computer 1 and the computer device 2.

The server computer 1 stores the learned data on the storage device 13. The learned data may include information for the travel distance per unit time, and interval and/or taken time in certain area in which the vehicle driven by the operator (vehicle for delivering the gas cylinder to the consumer) travels. In this case, the controller 11 of the server computer 1 determines, from the learned data, the route from the current location calculated in step S311 to the consumer's address, and calculates, from the learned data, the time to be taken for the vehicle to arrive at the consumer's address. In transmitting the current location in step S312, the controller 31 may transmit, to the computer device 2, the calculated time to be taken for the vehicle to arrive at the consumer's address. In this way, the consumer can know the current location for the operator and the time to be taken for the operator to arrive at the consumer's address by checking the information on the display device 25 of the computer device 2.

As described above, the location providing system 100 obtains, in response to the request (location provide request message) from the computer device 2, the current location for the operator who visits the consumer's home according to the location where the computer device 3 used by the operator is currently located, and transmits the current location to the computer device 2. In this way, the consumer can know the current location for the operator in real time, thereby allowing the consumer to expect when the operator arrives at the consumer's home by checking the current location for the operator. Also, it allows the consumer to expect the time taken and/or distance traveled until the operator arrives at the consumer's home.

### Second Embodiment

Next, a location providing system 100 is described in detail according to a second embodiment. The configuration of the location providing system 100 is the same as that in the first embodiment. In the description in the second embodiment, the same reference numbers are used as in the first embodiment unless otherwise stated. The second embodiment, in addition to the example described in the first embodiment, provides the example in which when the current location for the operator is transmitted to the computer device 2 used by the consumer, the information about what number of the work's turn to be performed for the consumer is provided.

In the example described in the first embodiment, the current location for the operator is transmitted to the computer device 2 used by the consumer. Since the operator may performs a plurality of works for a plurality of consumers respectively on the same work scheduled date, if the operator's work is delayed, only providing the current location for the operator may cause the considerable difference between the time expected by the consumer when the operator arrives at the consumer's home and the time when the operator actually arrives at the consumer's home. The second embodiment provides the example in which the location providing system 100 provides, when transmitting the current location to the computer device 2 used by the consumer, the information for the number of uncompleted works for the plurality of works, and what number of the work's turn to be performed for the consumer, thereby enhancing the accuracy of expecting the time when the operator arrives at the consumer's home.

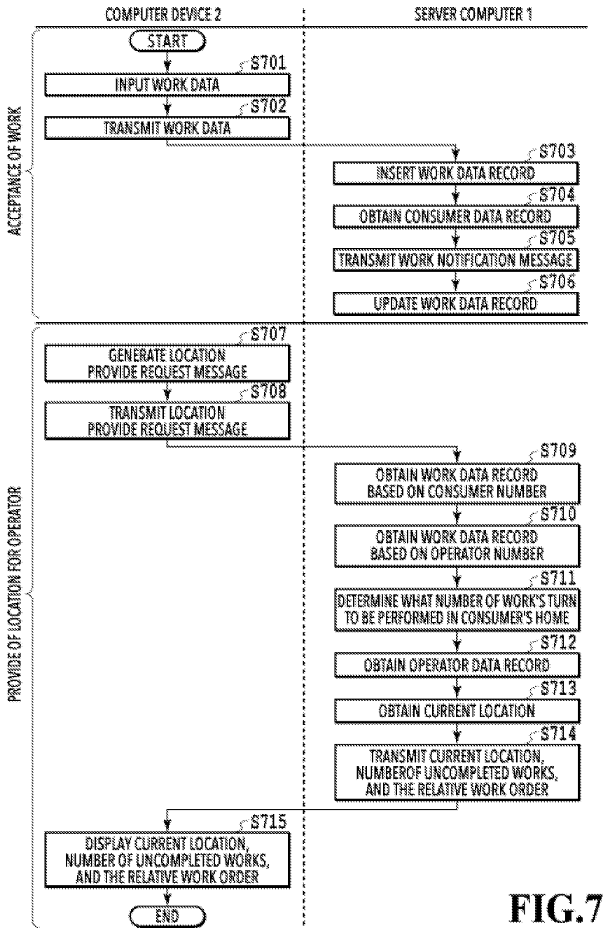

Next, referring to the flow diagram of FIG. 7, operations performed by the location providing system 100 are described according to the second embodiment. In the operations in FIG. 7, the server computer 1 and the computer device 2 or the server computer 3 exchange the data inputted into the Web document according to HTTP. The Web document is transmitted from the server computer 1 to the computer device 2 or the server computer 3.

In the operations in FIG. 7, since the operations in steps S701 to S709 and S712 to S713 are the same as the operations in steps S301 to S309 and S310 to S311 in FIG. 3, the description for these operations is omitted.

In step S710, the controller 11 of the server computer 1 obtains the work data records from the work data table 400 based on the operator number set in the operator number field 401 of the work data record obtained in S709. The work data records are obtained in the same way as in the above-mentioned operation in step S310.

In the operation of step S710, all work data records are obtained indicating the uncompleted works to be performed by the operator on the work scheduled date. In this instance, at each time when the operator completes the work, the computer device 3 transmits the information indicating the completion of the work (including at least operator number and work number) to the server computer 1. In this way, the controller 11 of the server computer 1 updates, for the work data record in the work data table 400, the value set in the status field 404 to “completed”. When the plurality of work data records are obtained in S710, it means that the operator performs the plurality of works for the plurality of consumers respectively on the same work scheduled date. Hereinafter, the number of obtained work data records is referred to as “the number of uncompleted works”.

Then, the controller 11 reorders the work data records obtained in step S710 in ascending order of the value set in the work scheduled date field 405. Then the controller 11 determines, among the reordered work data records, what number of work's turn corresponding to the work data record obtained in step S709 (i.e. work data record for the work to be performed in the consumer's home). That is, it is determined what number of work's turn to be performed in the consumer's home among the uncompleted works (step S711). Hereinafter, the number of work's turn is referred to as “the relative work order”.

In the operation of step S714, the controller 11 transmits, via the communication device 14 to the computer device 2, the current location calculated in step S713, the number of uncompleted works obtained in step S710, and the relative work order determined in S711. The controller 21 of the computer device 2 receives, via the communication device 23, the current location, the number of uncompleted works, and the relative work order, and displays, on the screen interface of the display device 25, the current location, the number of uncompleted works (e.g. five numbers), and the relative work order (e.g. fourth) (step S715). The current location, the number of uncompleted works, and the relative work order are embedded in the Web document for display.

The controller 11 may calculate the approximate time for the operator to arrive at the consumer's home based on the work data record obtained in step S710, the current location, the number of uncompleted works, and the relative work order. It is assumed that for example the work data records are obtained shown in Table 1 in step S710. The intended consumer corresponds to the consumer allocated the consumer number shown in fourth work data record in Table 1. Table 1 shows the example in which there are three remained uncompleted works before the work for the consumer allocated the consumer number “A1923850”, and the current location calculated in step S713 is currently in the consumer's home (allocated the consumer number “A1923847” (i.e. the operator is currently performing the work in the consumer's home (allocated the consumer number “A1923847”)).

TABLE 1

| | | | WORK | |
|---|---|---|---|---|
| OPERATOR | WORK | CONSUMER | SCHEDULED | WORK |
| NUMBER | NUMBER | NUMBER | DATE | TYPE |
| B1277345 | C10288948 | A1923847 | 201806201500 | 1 |
| B1277345 | C10288949 | A1923848 | 201806201600 | 1 |
| B1277345 | C10288950 | A1923849 | 201806201700 | 1 |
| B1277345 | C10288951 | A1923850 | 201806201800 | 1 |
| B1277345 | C10288952 | A1923851 | 201806201900 | 1 |

Let the work and the consumer corresponding to the first work data record are referred to as “work 1” and “consumer 1” respectively. Let the work and the consumer corresponding to the second work data record are referred to as “work 2” and “consumer 2” respectively. Let the work and the consumer corresponding to the third work data record are referred to as “work 3” and “consumer 3” respectively. Let the work and the consumer corresponding to the fourth work data record are referred to as “work 4” and “consumer 4” respectively.

The above-mentioned calculation of the approximate time is described in detail. The controller 11 calculates the average (expected) time to complete respective works before the work for the intended consumer (consumer 4), that is, calculates the average (expected) time to complete works 1 to 3 respectively. Then, controller 11 calculates the time for the operator to move from the consumer 1's home to consumer 2's home, calculates the time for the operator to move from the consumer 2's home to consumer 3's home, and calculates the time for the operator to move from the consumer 3's home to consumer 4's home.

The average (expected) time to complete the respective works 1 to 3 may be calculated based on the value set in the work type field of the work data record obtained in step S710. Since the work description and average time to complete are different, the average time can be statistically obtained and stored in the storage device 13 for each work type. For example, in the case of work type “1: delivery of gas cylinder”, the average time to complete is 30 minutes. In the case of work type “2: inspection of gas meter”, the average time to complete is 1 hour.

Further, the controller 11 may calculate the time for the operator to move between the consumer's homes based on the address set in the address field 503 of the consumer data records corresponding to the consumers 1 to 4 respectively. By calculating the average time to complete works and time for the operator to move, it can calculate the approximate time for the operator to arrive at the intended consumer's home.

As described above, the location providing system 100 according to the second embodiment allows the consumer to know, when delivering the gas cylinder, the number of uncompleted works and the relative work order in which the operator performs the works for the consumer in addition to the current location, thereby improving the accuracy for the consumer to expect the arrival time for the operator.

Although the second embodiment provides the example in which the work data records are reordered in ascending order of the work scheduled date and the relative work order is determined based on the reordered work data records, the work data records may be reordered based on criteria other than the work scheduled date and the relative work order may be determined based on the reordered work data records.

### Third Embodiment

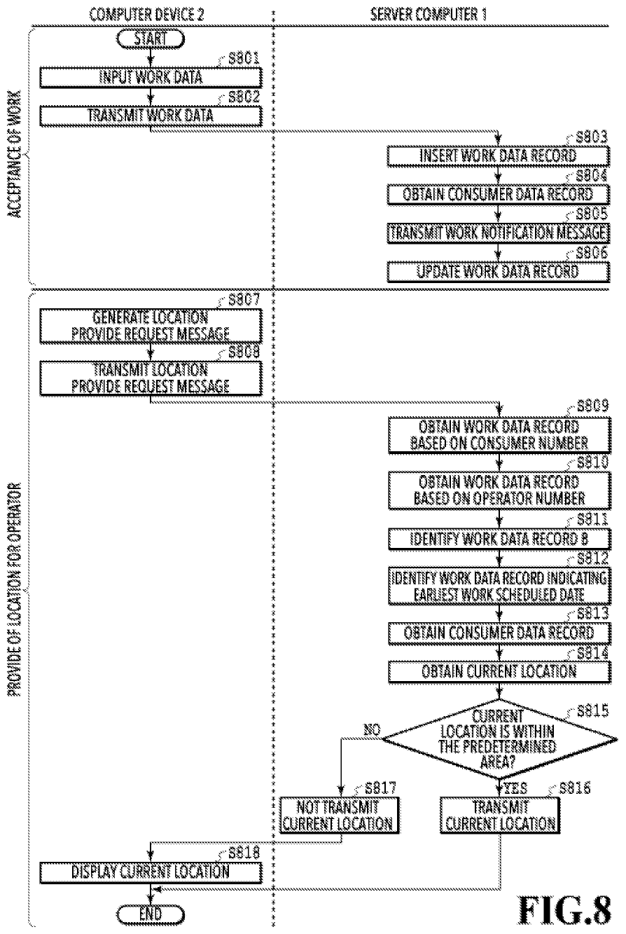

Next, a location providing system 100 is described in detail according to a third embodiment. Referring to the flow diagram of FIG. 8, operations performed by the location providing system 100 are described according to the third embodiment. The configuration of the location providing system 100 is the same as that in the first embodiment. In the description in the third embodiment, the same reference numbers are used as in the first embodiment unless otherwise stated. The third embodiment, in addition to the example described in the first embodiment, provides the example in which providing the current location for the operator is restricted in order to protect the privacy for the consumers. More specifically, the third embodiment provides the example in which when one consumer requests to provide the current location for the operator, providing the another consumer's address resulting from providing the current location for the operator is restricted. For example, it is assumed that when the operator is currently located in the consumer B's home before visiting the consumer A's home, the consumer A, if being provided with the location where the operator is currently located (in the consumer B's home), the consumer A can know the consumer B's address. The location providing system 100 according to the third embodiment can avoid the above case.

In the operations in FIG. 8, since the operations in steps S801 to S809 are the same as the operations in steps S301 to S309, the description for these operations is omitted. In the operations in FIG. 8, the server computer 1 and the computer device 2 or the server computer 3 exchange the data inputted into the Web document according to HTTP. The Web document is transmitted from the server computer 1 to the computer device 2 or the server computer 3.

In the operation of step S810, the controller 11 of the server computer 1 obtains the work data record from the work data table 400 based on the operator number set in the operator number field 401 of the work data record obtained in step S809. The work data record includes the value set in the status field 404 indicating that the work is uncompleted (e.g. value other than “2: completed”), and is obtained on the condition that the date set in the work scheduled date field 405 is the same as the date when the operation of S810 is performed.

In the operation of step S810, all work data records are obtained indicating that the operator is to perform the works in the scheduled date and the works are uncompleted. If the plurality of work data records are obtained, it means that the operators is to perform the plurality of works for the plurality of consumers respectively. If the plurality of work data records are obtained, the controller 11 compares the work data records obtained in step S810 with the work data record obtained in step S809 (work data record A), and identifies, among the work data records obtained in step S810, the work data record different from the work data record (work data record B) (step S811). The plurality of work data records B may be identified. That is, the work data record A corresponds to the work for the consumer A (i.e. consumer transmitted the request message in step S808), and the work data records B correspond to the work for the consumers other than the consumer A for which the same operator performs.

Then, the controller 11 reorders the work data records identified in step S811 in ascending order of the date set in the work scheduled date field 405, and identifies the work data record indicating the earliest work scheduled date (step S812). In the operation of step S810, since the work data records indicating that the works are uncompleted, the work data record indicating the earliest work scheduled date indicates the work for which the operator is currently performing or the operator is to perform immediately after.

Then, the controller 11 obtains the consumer data record (e.g. consumer data record B) from the consumer data table 500 based on the consumer number set in the consumer number field 403 of the work data record B (step S813).

In the operation of step S815, the controller 11 compares the current location calculated in step S814 and the address set in the address field 503 of the consumer data record obtained in step S813 (e.g. consumer data record B), and determines whether the current location and the address are within a predetermined area. According to the operations in FIG. 8, since the consumer data record B is obtained in step S813 as the consumer data record B, and the location where the operator is currently located is near the consumer B's address, it is determined whether the current location is within the predetermined area from the consumer B's address set in the address field 503. The predetermined area may be preset, and set to the values indicating the distance 10 meters from the address set in the address field 503 for example. If it is determined that the current location is within the predetermined area from the address set in the address field 503 (e.g. within 20 meters), the controller 11 does not transmit, to the computer device 2, the current location calculated in step S814 (step S816). If it is determined that the current location is beyond the predetermined area, the controller 11 transmits the current location to the computer device 2 (step S817).

In the operation of step S815, it is determined whether the current location is within the predetermined area from the address of the consumer's home other than the consumer that transmitted the request message in step S808 (e.g. consumer B′ address in which the operator is currently performing the work or in which the operator is to perform the work or in which the operator completed the work). If it is determined that the current location is within the predetermined area from the consumer's address (it means that the operator is currently located in or near the consumer B′ address), providing the current location is restricted in order for consumer A not to know the consumer B's address, thereby protecting the consumer B's privacy.

In the operation of step S812, the work data record indicating the earliest work scheduled date is identified among the plurality of work data records B, alternatively to this operation, the current location may be compared to the consumer's addresses set in the plurality of work data records respectively. In this case, the consumer data records are obtained from the consumer data table 500 based on the consumer number set in the consumer number field 403 of each of the plurality of work data records.

While the operation of step S818, the current location transmitted in step S817 is displayed on the display device 25 of the computer device 2, the current location may be transmitted to the computer device 2 also in step S816, and if it is determined that the address is within the predetermined area in step S815, the computer device 2 may control not to display the current location.

As described above, the location providing system 100 according to the third embodiment allows for, when checking the current location in delivering the gas cylinder to the consumer, avoiding to provide the consumer with other consumer's address for example.

It is noted that the described configuration of hardware is exemplary, and other configuration may be considered. Also, the order in which the operations are performed described in the embodiments are not necessarily performed in the described order, and may be performed in any order. Further, the additional operation may be added and some of the described operations may be omitted without departing from the basic concept of the embodiment.

The program including the computer executable instruction may cause, when executed by the server computer 1 and/or computer device 2, the server computer 1 and/or computer device 2 to perform the operations according to the embodiment. The program may be stored in the non-transitory storage medium. The example of the non-transitory storage medium may include read only memory (ROM), random access memory (RAM), register, cache memory, semiconductor memory device, magnetic media such as internal hard disk and removable disk, magnetic-optical media, and optical media such as CD-ROM and DVD.

### REFERENCE SIGNS LIST

1 server computer
2 computer device
3 computer device
4 network

1. A system for providing location where an operator who performs a work related to a gas service is currently located, the system comprising a controller, a communication device, and a storage device, the storage device stores operator information associated with the work,
the controller configured to:
transmit, via the communication device to a first computer device used by a consumer, notification of the work from the operator to the consumer;
receive, via the communication device from the first computer device, a request for receiving current location for the operator who performs the work associated with the notification;
in response to the request, obtain from the storage device, the operator information associated with the work; and
transmit, via the communication device to the first computer device, the obtained current location.

2. The system according to claim 1,
the storage device further stores work scheduled date for the consumer associated with the operator information,
the controller is further configured to:
obtain, from the storage device, the work scheduled date associated with the obtained operator information; and
transmit, via the communication device to the first computer device, the current location before predetermined time from the work scheduled date.

3. The system according to claim 1,
wherein the operator information stored in the storage device is associated with a plurality of works for a plurality of consumers respectively,
the controller is further configured to:
when receiving the request,
obtain, from the storage device, based on the request, the plurality of works for the plurality of consumers for which the operator performs;
determine, from the plurality of consumers, work order in which the operator performs the works for the consumers; and
transmit, via the communication device to the first computer device, the obtained current location and the work order.

4. The system according to claim 1,
the storage device further stores address for a second consumer different from the consumer who requested,
the controller is further configured to:
determine whether the obtained current location is within a predetermined area from the address stored in the storage device; and
if the current location is within the predetermined area, not transmit, via the communication device to the first computer device, the obtained current location.

5. A computer-implemented method for providing location where an operator who performs a work related to a gas service is currently located, the computer stores operator information associated with the work in a storage device, the method comprising:
transmitting, to a first computer device, notification of the work from the operator to the consumer;
receiving, from the first computer device, a request for receiving current location for the operator who performs the work associated with the notification;
in response to the request, obtaining from the storage device, the operator information associated with the work; and
transmitting, to the first computer device, the obtained current location.

6. A computer storage medium storing program including a computer executable instruction, when executed by a computer, causing the computer to perform for providing location where an operator who performs a work related to a gas service is currently located, the computer stores operator information associated with the work in a storage device, the method:
transmuting, to a first computer device, notification of the work front the operator to the consumer;
receiving, from the first computer device, a request for receiving current location for the operator who performs the work associated with the notification;
in response to the request, obtaining from the storage device, the operator information associated with the work; and
transmitting, to the first computer device, the obtained current location.
